(19) United States
(12) Patent Application Publication
(10) Pub. No.: US 2015/0251588 A1
(43) Pub. Date: Sep. 10, 2015

(54) PRIVACY WINDOW ASSEMBLY

(71) Applicant: Ford Global Technologies, LLC, Dearborn, MI (US)

(72) Inventors: Stuart C. Salter, White Lake, MI (US); Paul Kenneth Dellock, Northville, MI (US); John Robert Van Wiemeersch, Novi, MI (US); James J. Surman, Clinton Township, MI (US); Patrick Kevin Holub, Novi, MI (US)

(73) Assignee: Ford Global Technologies, LLC

(21) Appl. No.: 14/721,274

(22) Filed: May 26, 2015

Related U.S. Application Data
(63) Continuation-in-part of application No. 14/603,636, filed on Jan. 23, 2015.
Application No. 14/603,636 is a continuation-in-part of application No. 14/086,442, filed on Nov. 21, 2013.

(51) Int. Cl. B60Q 1/26; F21V 9/16; F21V 7/00; B60Q 1/00

(52) U.S. Cl. CPC B60Q 1/268; B60Q 1/2607; B60Q 1/2696; B60Q 1/0076; F21V 9/16; F21V 7/005

(57) ABSTRACT

A privacy window assembly of a vehicle is provided herein. The privacy window assembly includes a window of the vehicle and a light-producing assembly coupled to the window having a plurality of light sources. When the light sources are activated, visibility through at least a portion of the window becomes obscured to onlookers located outside the vehicle.

### CROSS-REFERENCE TO THE RELATED APPLICATIONS

This application is a continuation-in-part of U.S. patent application Ser. No. 14/603,636, filed Jan. 23, 2015, entitled “DOOR ILLUMINATION AND WARNING SYSTEM,” which is a continuation-in-part of U.S. patent application Ser. No. 14/086,442, filed Nov. 21, 2013, entitled “VEHICLE LIGHTING SYSTEM WITH PHOTOLUMINESCENT STRUCTURE.” The aforementioned related applications are hereby incorporated by reference in their entirety.

### FIELD OF THE INVENTION

The present invention generally relates to vehicle lighting systems and more particularly relates to vehicle lighting systems employing photoluminescent structures.

### BACKGROUND OF THE INVENTION

Illumination arising from the use of photoluminescent structures offers a unique and attractive viewing experience. It is therefore desired to implement such structures in automotive vehicles for various lighting applications.

### SUMMARY OF THE INVENTION

According to one aspect of the present invention, a privacy window assembly of a vehicle is provided. The privacy window assembly includes a window of the vehicle and a light-producing assembly coupled to the window having a plurality of light sources. When the light sources are activated, visibility through at least a portion of the window becomes obscured to onlookers located outside the vehicle.

According to another aspect of the present invention, a privacy window assembly of a vehicle is provided. The privacy window assembly includes a window of the vehicle and a light-producing assembly coupled to the window and having a plurality of light sources facing vehicle-outward. When the light sources are activated, visibility through at least a portion of the window becomes obscured to onlookers located outside the vehicle.

According to yet another aspect of the present invention, a privacy window assembly of a vehicle is provided. The privacy window assembly includes a window of the vehicle and a light-producing assembly coupled to the window. The light-producing assembly includes a plurality of light sources and a photoluminescent structure configured to luminesce in response to excitation by light emitted from the light sources. When the photoluminescent structure is in a luminescent state, visibility through at least a portion of the window becomes obscured to onlookers located outside the vehicle.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 illustrates a side perspective view of a vehicle equipped with a privacy window assembly, according to one embodiment;

FIG. 2 illustrates a perspective view of a door of the vehicle depicted in FIG. 1 arranged in an open position, above which a light-producing assembly is shown coupled to a window, according to one embodiment;

FIG. 3 is a cross-sectional view of the privacy window assembly depicted in FIGS. 1 and 2 taken along line III-III of FIG. 1;

FIG. 4 is a block diagram of a vehicle lighting system employing the privacy window assembly depicted in FIGS. 1 and 2, according to one embodiment.

### DETAILED DESCRIPTION OF THE PREFERRED EMBODIMENTS

As required, detailed embodiments of the present invention are disclosed herein. However, it is to be understood that the disclosed embodiments are merely exemplary of the invention that may be embodied in various and alternative forms. The figures are not necessarily to a detailed design and some schematics may be exaggerated or minimized to show function overview. Therefore, specific structural and functional details disclosed herein are not to be interpreted as limiting, but merely as a representative basis for teaching one skilled in the art to variously employ the present invention.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

The following disclosure is related to a privacy window assembly of a vehicle. The privacy window assembly is operable to reduce visibility through a window of the vehicle to provide a vehicle occupant(s) with privacy from onlookers located outside the vehicle. While the privacy window assembly is contemplated for use in automobiles, it should be appreciated that the privacy window assembly provided herein may be similarly used in other types of vehicles designed to transport one or more passengers such as, but not limited to, aircraft, watercraft, and locomotives.

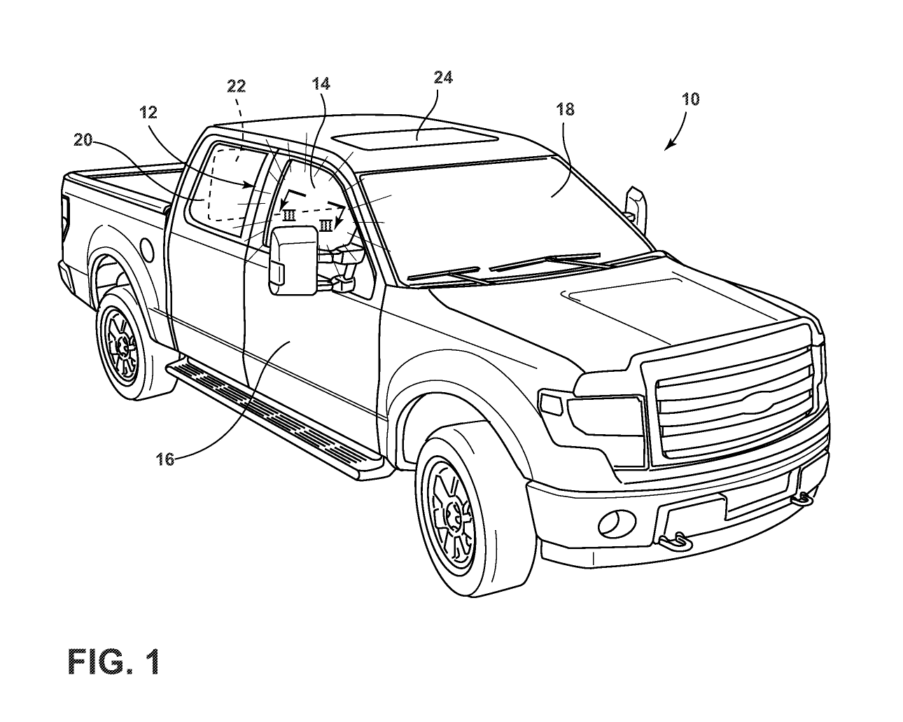

Referring to FIG. 1, a vehicle 10 is generally shown having a privacy window assembly 12, according to one embodiment. The privacy window assembly 12 may include a window of the vehicle 10, exemplarily shown as side window 14 mounted within door 16. In operation, at least a portion of the side window 14 may illuminate as demonstrated by the lines extending outwardly from the side window 14. As a result of the illumination, the visibility through the side window 14 becomes obscured to onlookers located outside the vehicle 10. The side window 14 may be configured to illuminate when a vehicle occupant(s) desires privacy. Additionally or alternatively, other windows of the vehicle 10, such as front windshield 18, side window 20, rear windshield 22, and/or roof window 24 (e.g., moonroof/sunroof) may be similarly configured to illuminate in other embodiments.

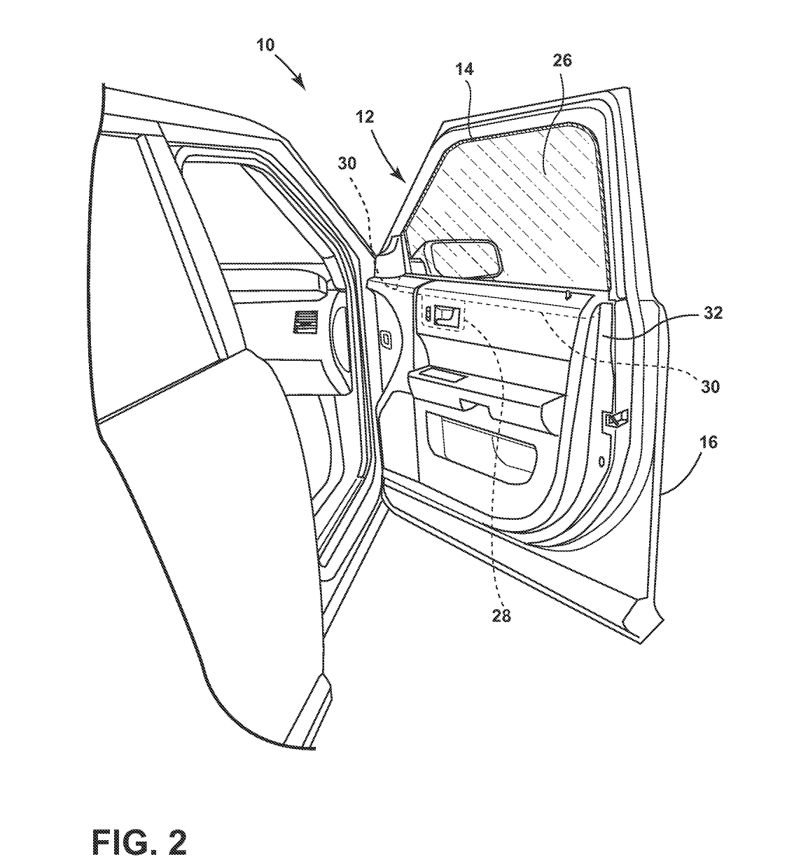

Referring to FIG. 2, door 16 is shown in an open position. The privacy window assembly 12 includes a light-producing assembly 26 that is coupled to the side window 14 of the vehicle 10 and is responsible for the illumination depicted in FIG. 1. For purposes of understanding, a portion of the side window 14 is slightly shaded by broken lines to illustrate the area of the side window 14 that is covered by the light-producing assembly 26 according to one embodiment. However, it is to be understood that the light-producing assembly 26 is generally concealed when in a deactivated state so as not to obstruct the view of vehicle occupants. It is also to be understood that the light-producing assembly 26 may be configured in a variety of dimensions such that it occupies a substantial entirety of the side window 14 or a portion thereof.

As is further shown in FIG. 2, the light-producing assembly 26 may be electronically connected to a controller 28 via conductive leads 30, which may be wired through a door frame 32 of the door 16. The controller 28 may be positioned within the door frame 32 or in other areas of the vehicle 10 and is electrically connected to a power source (not shown), which includes a vehicle power source or alternative power source.

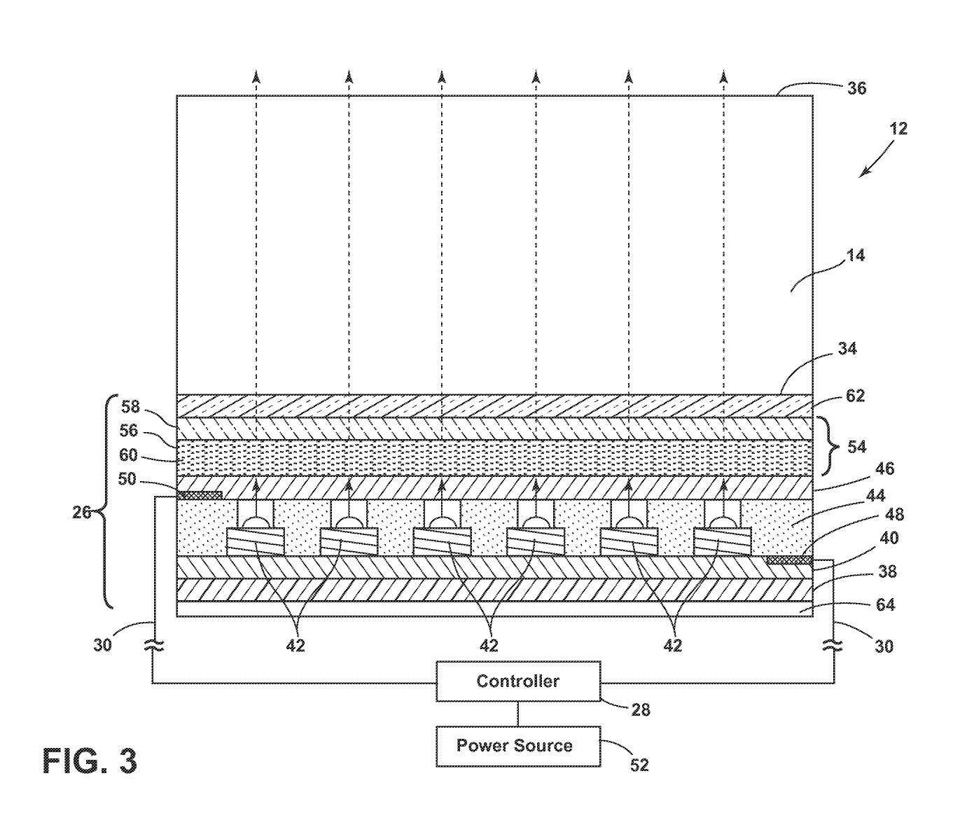

Referring to FIG. 3, a cross-sectional view of the privacy window assembly 12 depicted in FIGS. 1 and 2 is shown according to one embodiment, in which the light-producing assembly 26 is coupled the side window 14 at window portion 34, which faces the toward interior of the vehicle 10. In another embodiment, the light-producing assembly 26 may be coupled to the side window 14 at window portion 36, which faces toward the exterior of the vehicle 10. In yet another embodiment, the light-producing assembly 26 may be integrated with the side window 14 and positioned between window portions 34 and 36. However, by coupling the light-producing assembly 26 to window portion 34 of the side window 14, the light-producing assembly 26 is not in direct contact with the external environment. While the light-producing assembly 26 is shown in a planar configuration, it should be appreciated that non-planar configurations are possible in instances where it is desired to couple the light-producing assembly 26 to a curved window portion.

With respect to the illustrated embodiment, the light-producing assembly 26 includes a substrate 38, which may include a substantially transparent polycarbonate, poly-methyl methacrylate (PMMA), or polyethylene terephthalate (PET) material on the order of 0.005 to 0.060 inches thick. A positive electrode 40 is arranged over the substrate 38 and includes a substantially transparent conductive material such as, but not limited to, indium tin oxide. The positive electrode 40 is electrically connected to at least a portion of a plurality of light sources such as light emitting diodes (LEDs) 42, which are arranged within a semiconductor ink 44 and applied over the positive electrode 40. Likewise, a substantially transparent negative electrode 46 is also electrically connected to at least a portion of the LEDs 42. The negative electrode 46 is arranged over the semiconductor ink 44 and includes a transparent or translucent conductive material such as, but not limited to, indium tin oxide. Additionally, each of the positive and negative electrodes 40, 46 are electrically connected to a controller, such as controller 28 depicted in FIG. 2 via a corresponding bus bar 48, 50 connected to one of the conductive leads 30. The bus bars 48, 50 may be printed along opposite edges of the positive and negative electrodes 40, 46 and the points of connection between the bus bars 48, 50 and the conductive leads 30 may be at opposite corners of each bus bar 48, 50 to promote uniform current distribution along the bus bars 48, 50. The controller 28 may also be electrically connected to a power source 52, which may correspond to a vehicular power source operating at 12 to 16 VDC.

The LEDs 42 may be dispersed in a random or controlled fashion within the semiconductor ink 44 and are disposed facing vehicle-outward and configured to emit focused or non-focused light. The LEDs 42 may correspond to micro-LEDs of gallium nitride elements on the order of 5 to 400 microns in size and the semiconductor ink 44 may include various binders and dielectric material including, but not limited to, one or more of gallium, indium, silicon carbide, phosphorous, and/or translucent polymeric binders. In this manner, the semiconductor ink 44 may contain various concentrations of LEDs 42 such that the density of the LEDs 42 may be adjusted for various lighting applications. The semiconductor ink 44 can be applied through various printing processes, including ink jet and silk screen processes to selected portion(s) of the positive electrode 40. More specifically, it is envisioned that the LEDs 42 are dispersed within the semiconductor ink 44, and shaped and sized such that a substantial quantity of them align with the positive and negative electrodes 40, 46 during deposition of the semiconductor ink 44. The portion of the LEDs 42 that ultimately are electrically connected to the positive and negative electrodes 40, 46 may be selectively activated and deactivated by the controller 28. Additional information regarding the construction of light-producing assemblies is disclosed in U.S. Patent Publication No. 2014-0264396 A1 to Lowenthal et al., entitled “ULTRA-THIN PRINTED LED LAYER REMOVED FROM SUBSTRATE,” filed Mar. 12, 2014, the entire disclosure of which is incorporated herein by reference.

Referring still to FIG. 3, the light-producing assembly 26 further includes at least one photoluminescent structure 54 arranged over the negative electrode 46 as a coating, layer, film or other suitable deposition. With respect to the presently illustrated embodiment, the photoluminescent structure 54 may be arranged as a multi-layered structure including an energy conversion layer 56 and an optional stability layer 58. The energy conversion layer 56 includes at least one photoluminescent material 60 having energy converting elements with phosphorescent or fluorescent properties. For example, the photoluminescent material 60 may include organic or inorganic fluorescent dyes including rylenes, xanthenes, porphyrins, phthalocyanines. Additionally or alternatively, the photoluminescent material 60 may include phosphors from the group of Ce-doped garnets such as YAG:Ce. The energy conversion layer 56 may be prepared by dispersing the photoluminescent material 60 in a polymer matrix to form a homogenous mixture using a variety of methods. Such methods may include preparing the energy conversion layer 56 from a formulation in a liquid carrier medium and coating the energy conversion layer 56 to the negative electrode 46 or other desired substrate. The energy conversion layer 56 may be applied to the negative electrode 46 by painting, screen printing, flexography, spraying, slot coating, dip coating, roller coating, and bar coating. Alternatively, the energy conversion layer 56 may be prepared by methods that do not use a liquid carrier medium. For example, the energy conversion layer 56 may be rendered by dispersing the photoluminescent material 60 into a solid state solution (homogenous mixture in a dry state) that may be incorporated in a polymer matrix formed by extrusion, injection, compression, calendaring, thermoforming, etc.

To protect the photoluminescent material 60 contained within the energy conversion layer 56 from photolytic and thermal degradation, the photoluminescent structure 54 may optionally include stability layer 58. The stability layer 58 may be configured as a separate layer optically coupled and adhered to the energy conversion layer 56 or otherwise integrated therewith. The stability layer 58 may be combined with the energy conversion layer 56 through sequential coating or printing of each layer, sequential lamination or embossing, or any other suitable means. The photoluminescent structure 54 may be coupled to window portion 34 via an adhesive layer 62 arranged over the photoluminescent structure 54. Additional information regarding the construction of photoluminescent structures is disclosed in U.S. Pat. No. 8,232,533 to Kingsley et al., entitled “PHOTOLYTICALLY AND ENVIRONMENTALLY STABLE MULTILAYER STRUCTURE FOR HIGH EFFICIENCY ELECTROMAGNETIC ENERGY CONVERSION AND SUSTAINED SECONDARY EMISSION,” filed Nov. 8, 2011, the entire disclosure of which is incorporated herein by reference.

In operation, the photoluminescent structure 54 is configured to luminesce in response to excitation by light emitted by the LEDs 42. More specifically, the light emitted by LEDs 42 undergoes an energy conversion where it's converted by the photoluminescent material 60 and re-emitted therefrom at a different wavelength. Light emitted by the LEDs 42 is referred to herein as inputted light, whereas light re-emitted from the photoluminescent material 60 is referred to herein as converted light. According to one embodiment, the photoluminescent material 60 may be formulated to convert inputted light into a longer wavelength light, otherwise known as down conversion. Alternatively, the photoluminescent material 60 may be formulated to convert inputted light into a shorter wavelength light, otherwise known as up conversion. Under either approach, light converted by the photoluminescent material 60 may be immediately outputted from the photoluminescent structure 54 or otherwise used in an energy cascade, wherein the converted light serves as inputted light to excite another formulation of photoluminescent material located within the energy conversion layer 56, whereby the subsequent converted light may then be outputted from the photoluminescent structure 54 or used as inputted light, and so on. With respect to the energy conversion processes described herein, the difference in wavelength between the inputted light and the converted light is known as the Stokes shift and serves as the principle driving mechanism for an energy conversion process corresponding to a change in wavelength of light.

In some embodiments, the photoluminescent structure 54 may exhibit Lambertian emittance, whereby a portion of the converted light may be emitted in a vehicle-inward direction. As such, the light-producing assembly 26 may optionally include a reflective layer 64 coupled to the substrate 38 to redirect converted light in a vehicle-outward direction. The reflective layer 64 may be embodied as a film and should not overly obstruct the view of vehicle occupants when the light-producing assembly 26 is in a deactivated state, which is defined herein as the LEDs 42 being turned OFF such that the photoluminescent structure 54 does not exhibit luminescence. The reflective layer 64 may also serve to protect the light-producing assembly 26 from physical and chemical damage arising from environmental exposure. In alternative embodiments where the photoluminescent structure 54 is exposed to the environment, such as when the light-producing assembly 26 is arranged on top of window portion 36, a separate protective layer may be arranged over the photoluminescent structure 54 to accomplish the same.

According to one embodiment, the photoluminescent material 60 is formulated to have a Stokes shift resulting in the converted light having an emission spectrum expressed in a desired color, which may vary depending on the lighting application. For example, the energy conversion process may be undertaken by way of down conversion, whereby the inputted light includes light on the lower end of the visibility spectrum such as blue, violet, or ultraviolet (UV) light. Doing so enables blue, violet, or UV LEDs to be used as the LEDs 42, which may offer a relative cost advantage over other colors of LEDs or simply using LEDs of the desired color and omitting the photoluminescent structure 54 altogether.

In alternative embodiments, the energy conversion layer 56 may include more than one distinct photoluminescent material, each configured to convert inputted light into a longer or shorter wavelength light. In one embodiment, the distinct photoluminescent materials may be interspersed within the energy conversion layer 56. Alternatively, the distinct photoluminescent materials may be isolated from each other if desired. For example, the distinct photoluminescent materials may be arranged to alternate in a tessellation or other pattern. In either embodiment, each distinct photoluminescent material may be uniquely excited by a corresponding portion of the LEDs 42, which may be variously arranged. In some embodiments, each distinct photoluminescent material may be formulated to have a Stokes shift resulting in the associated converted light having an emission spectrum expressed in a unique color such that the resultant luminescence corresponds to a light mixture of the converted light from each distinct photoluminescent material. By mixing the converted light outputted from two or more distinct photoluminescent materials, a greater diversity of colors may be expressed that would otherwise be unachievable through the excitation of a single photoluminescent material. Contemplated colors include light mixtures containing any combination of red, green, and blue light, all of which may be achieved by selecting the appropriate combinations of photoluminescent materials and LEDs. Additional information on the arrangements of distinct photoluminescent materials and corresponding LEDs is disclosed in U.S. patent application Ser. No. 14/697,035 to Salter et al., entitled “LIGHT-PRODUCING ASSEMBLY FOR A VEHICLE,” filed Apr. 27, 2015, the entire disclosure of which are incorporated herein by reference.

In operation, the controller 28 may control the intensity of the LEDs 42 to ultimately affect the brightness in which the photoluminescent structure 54 luminesces. For example, increasing the intensity of the LEDs 42 generally results in the photoluminescent structure 54 exhibiting a brighter luminescence. The controller 28 may control the intensity of the LEDs 42 through pulse-width modulation or direct current control. When the light-producing assembly 26 is active, the controller 28 may control the light emission duration of the LEDs 42 to affect the duration in which the photoluminescent structure 54 luminesces. For example, the controller 28 may activate the LEDs 42 for an extended duration such that the photoluminescent structure 54 exhibits sustained luminescence. Alternatively, the controller 28 may flash the LEDs 42 at varying time intervals such that the photoluminescent structure 54 exhibits a blinking effect.

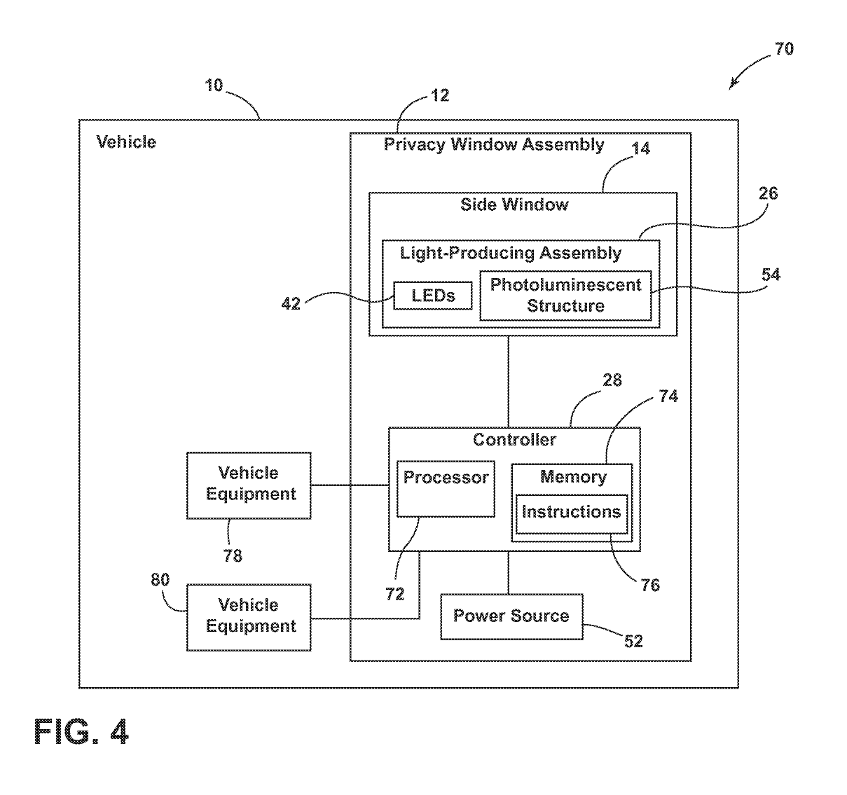

Referring to FIG. 4, a block diagram of a lighting system 70 is shown according to one embodiment with continued reference to the privacy window assembly 12 depicted in FIGS. 1 and 2. The privacy window assembly 12 includes the light-producing assembly 26 and may be arranged pursuant to that depicted in FIG. 3. As shown, the light-producing assembly 26 is electrically connected to controller 28, which is electrically connected to the power source 52. In one embodiment, the power source 52 may correspond to a vehicular power source operating at 12 to 16 VDC. The controller 28 may be variously located within the vehicle 10 and includes a processor 72 in communication with a memory 74. The memory 74 includes instructions 76 stored thereon that are executable by the processor 72. The instructions 76 enable the controller 28 to selectively activate the LEDs 42 that are electrically connected to the positive and negative electrodes 40, 46. The controller 28 may be communicatively coupled to one or more vehicle equipment 78 and/or a user input device 80 and use signals received therefrom to control the activation state of the light-producing assembly 26. The user input device 80 may correspond to a center console touch screen display or a portable electronic device such as a key fob or smart phone. The controller 28 may communicate with the one or more vehicle equipment 78 and/or user input device 80 and may receive signals therefrom directed to a vehicle-related condition such as, but not limited to, an operational state of the vehicle, a status related to a particular vehicle equipment (e.g., door open status), a key fob proximity status, a remote signal sourced from a portable electronic device, a status related to an operating environment of the vehicle (e.g., an ambient light level), or any other information or control signal that may be utilized to activate or otherwise adjust the output of the light-producing assembly 26.

According to one embodiment, the controller 28 activates the LEDs 42 in response to a user command inputted via the user input device 80, thereby causing the photoluminescent structure 54 to luminesce and visibility through the side window 14 to become obscured. The controller 28 subsequently deactivates the LEDs 42 in response to another user command or when the vehicle 10 is placed in drive, thereby causing the photoluminescent structure 54 to cease luminescing and the side window 14 to become unobscured. It should be appreciated that the controller 28 may be connected to additional light-producing assemblies and configured to selectively activate the LEDs of each light-producing assembly based on one or more vehicle-related conditions. For example, another light-producing assembly 26 may be arranged on a window portion of another window, such as side window 20, and the controller 28 may activate the associated LEDs 42 to blink in conjunction with a turn signal of the vehicle 10. The resultant illumination may be perceived on a portion of the side window 20 and function as a turn light.

For the purposes of describing and defining the present teachings, it is noted that the terms “substantially” and “approximately” are utilized herein to represent the inherent degree of uncertainty that may be attributed to any quantitative comparison, value, measurement, or other representation. The term “substantially” and “approximately” are also utilized herein to represent the degree by which a quantitative representation may vary from a stated reference without resulting in a change in the basic function of the subject matter at issue.

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A privacy window assembly of a vehicle, comprising:
a window of the vehicle; and
a light-producing assembly coupled to the window and comprising a plurality of light sources, wherein when the light sources are activated, visibility through at least a portion of the window becomes obscured to onlookers located outside the vehicle.

2. The privacy window assembly of claim 1, wherein the window of the vehicle comprises one of a front windshield, a side window, a rear window, and a roof window.

3. The privacy window assembly of claim 1, wherein the plurality of light sources comprise a plurality of LEDs arranged within a semiconductor ink disposed between a positive electrode and a negative electrode, the positive and negative electrodes each being substantially transparent.

4. The privacy window assembly of claim 1, wherein the light-producing assembly further comprises a photoluminescent structure configured to luminesce in response to excitation by light emitted from the light sources.

5. The privacy window assembly of claim 4, wherein the plurality of light sources are each configured to emit one of an ultraviolet, violet, and a blue light.

6. The privacy window assembly of claim 1, wherein the light-producing assembly further comprises an at least partially reflective layer configured to redirect light in a vehicle-outward direction.

7. The privacy window assembly of claim 1, wherein the light-producing assembly is electrically connected to a controller configured to activate the plurality of light sources in response to at least one of a vehicle-related condition and a user command, and wherein if the plurality of light sources are in an activated state, the controller subsequently deactivates the plurality of light sources when the vehicle is placed in drive, thereby causing the window to become unobscured.

8. A privacy window assembly of a vehicle, comprising:
a window of the vehicle;
a light-producing assembly coupled to the window and comprising a plurality of light sources facing vehicle-outward, wherein when the light sources are activated, visibility through at least a portion of the window becomes obscured to onlookers located outside the vehicle.

9. The privacy window assembly of claim 8, wherein the window of the vehicle comprises one of a front windshield, a side window, a rear window, and a roof window.

10. The privacy window assembly of claim 8, wherein the plurality of light sources comprise a plurality of LEDs arranged within a semiconductor ink disposed between a positive electrode and a negative electrode, the positive and negative electrodes each being substantially transparent.

11. The privacy window assembly of claim 8, wherein the light-producing assembly further comprises a photoluminescent structure configured to luminesce in response to excitation by light emitted from the light sources.

12. The privacy window assembly of claim 11, wherein the plurality of light sources are each configured to emit one of an ultraviolet, violet, and a blue light.

13. The privacy window assembly of claim 8, wherein the light-producing assembly further comprises an at least partially reflective layer configured to redirect light in a vehicle-outward direction.

14. The privacy window assembly of claim 8, wherein the light-producing assembly is electrically connected to a controller configured to activate the plurality of light sources in response to at least one of a vehicle-related condition and a user command, and wherein if the plurality of light sources are in an activated state, the controller subsequently deactivates the plurality of light sources when the vehicle is placed in drive, thereby causing the window to become unobscured.

15. A privacy window assembly of a vehicle, comprising:
a window of the vehicle; and
a light-producing assembly coupled to the window and comprising:
a plurality of light sources; and
a photoluminescent structure configured to luminesce in response to excitation by light emitted from the light sources, wherein when the photoluminescent structure is in a luminescent state, visibility through at least a portion of the window becomes obscured to onlookers located outside the vehicle.

16. The privacy window assembly of claim 15, wherein the window of the vehicle comprises one of a front windshield, a side window, a rear window, and a roof window.

17. The privacy window assembly of claim 15, wherein the plurality of light sources comprise a plurality of LEDs arranged within a semiconductor ink disposed between a positive electrode and a negative electrode, the positive and negative electrodes each being substantially transparent.

18. The privacy window assembly of claim 17, wherein the plurality of light sources are each configured to emit one of an ultraviolet, violet, and a blue light.

19. The privacy window assembly of claim 15, wherein the light-producing assembly further comprises an at least partially reflective layer configured to redirect light in a vehicle-outward direction.

20. The privacy window assembly of claim 15, wherein the light-producing assembly is electrically connected to a controller configured to activate the plurality of light sources in response to at least one of a vehicle-related condition and a user command, and wherein if the plurality of light sources are in an activated state, the controller subsequently deactivates the plurality of light sources when the vehicle is placed in drive, thereby causing the window to become unobscured.
